(19) United States
(12) Patent Application Publication
(10) Pub. No.: US 2013/0190041 A1
(43) Pub. Date: Jul. 25, 2013

(54) Smartphone Speakerphone Mode With Beam Steering Isolation

(71) Applicants: Carlton Andrews, Austin, TX (US); Douglas Peeler, Austin, TX (US); Steven Lalla, Austin, TX (US)

(72) Inventors: Carlton Andrews, Austin, TX (US); Douglas Peeler, Austin, TX (US); Steven Lalla, Austin, TX (US)

(21) Appl. No.: 13/358,403

(22) Filed: Jan. 25, 2012

(51) Int. Cl. H04W 88/00; H04M 1/00; H04R 3/00

(52) U.S. Cl. 455/556.1; 381/92; 455/550.1

(57) ABSTRACT

A smartphone selectively supports a telephone call in a handset mode or a speakerphone mode by enabling or disabling microphones and speakers integrated in the smartphone. In the speakerphone mode, plural microphones determine a direction of a participant of a speakerphone telephone call so that audio of the speakerphone telephone call from plural speakers of the smartphone is beam steered towards the participant.

### BACKGROUND OF THE INVENTION

1. Field of the Invention

The present invention relates in general to the field of portable information handling system telephone handsets, and more particularly to a smartphone speakerphone mode with beam steering isolation.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Improved processing components have resulted in smaller and more compact portable information handling systems having capabilities on par with larger fixed-location desktop systems. End users have responded to these improved capabilities and the greater convenience of portable information handling systems by transitioning away from desktop information handling systems to use portable information handling systems as their primary work and home systems. The transition to portable information systems has included an increased reliance on ultraportable systems, such as tablet and smartphone systems. Smartphones are built in a housing sized to act as a telephone handset and typically include a touchscreen to present visual information, such as input/output interfaces that accept end user inputs. The housing supports a speaker and microphone placed in a telephone handset configuration that presents telephone calls in a conventional manner when the housing is proximate the ear and mouth of an end user. In addition to supporting telephone communications, smartphones typically include a web browser and e-mail capability. Smartphones are a convenient tool for end users to communicate by voice, text and e-mail, and also offer basic web browsing functions, however, the size of the housing generally limits smartphones from performing more advanced information processing functions available in larger portable information handling systems. For example, the relatively small size of the display integrated in a smartphone housing makes information more difficult to input to a touchscreen keyboard and to read. The small housing also limits the size and capability of components that can be included in a smartphone, such as the microphone and camera used to capture audible and visual inputs and the speaker used to output audible sounds.

One example of a challenge found in the usage of a smartphone is the use of a smartphone as a speakerphone. Smartphone microphone and speaker combinations are generally designed to operate as a handset and work quite well when held next to a head, but when placed on a table and used as a hands-free conferencing device, the audibility in both transmit and receive modes is typically poor. Poor audibility typically relates to the quality of speaker and microphone components that will fit in the housing. For example, the microphone picks up sounds from all directions, including extraneous noise, and the small radiating speaker can be heard from all directions but not well in any direction. The microphone of a smartphone generally has to be omni-directional in the speakerphone mode or the user would have to lean over the microphone to be heard. In a noisy or public environment, the microphone will typically pick up any sound from the surroundings. The speaker of a smartphone is often weak and difficult to hear, especially in noisy environments. End users tend to set the speaker volume loud to increase audibility, however, this tends to raise privacy concerns both because sound from the speaker radiates in all directions and because the end user tends to speak louder in response to the poor audibility of the speaker.

### SUMMARY OF THE INVENTION

Therefore a need has arisen for a system and method which provides improved usability of portable information handling systems in a telephone handset configuration when used as a speakerphone.

In accordance with the present invention, a system and method are provided which substantially reduce the disadvantages and problems associated with previous methods and systems for using a portable information handling system having a telephone handset configuration as a speakerphone. Plural microphones disposed in the portable information handling system detect sounds of a participant to a speakerphone telephone call for determining a direction to the participant. Plural speakers disposed in the portable information handling system apply the direction to the participant to form a beam of sounds from the speakerphone telephone call in the direction of the speaker.

More specifically, a wireless telephone handset has a housing that supports a processor, memory, a wireless telephone module to perform wireless telephone communication and plural microphones and speakers. One speaker and one microphone are integrated in the housing in a handset configuration so that an end user can hold the housing next to the end user's head to speak in the microphone and hear from the speaker as with a conventional telephone handset. The other microphones and speakers are disposed at the housing in positions that support beam forming for receiving sounds at the microphone and presenting sounds from the speakers in a predetermined direction. When a speakerphone telephone call is presented at the wireless telephone handset, a direction finder determines the direction to a participant of the speakerphone telephone call, such as by triangulating to an identified voice with the plural microphones. A beam former interfaced with the plural speakers applies the determined direction to form a beam of sounds output from the speakers towards the direction of the participant. If the wireless telephone handset is used in a handset mode instead of a speakerphone mode, then the speaker and microphone of the handset configuration are activated and the other speakers and microphones are deactivated to provide telephone communication as a handset rather than as a speakerphone.

The present invention provides a number of important technical advantages. One example of an important technical advantage is that a portable information handling system having a telephone handset configuration provides improved audibility in a speakerphone mode. Multiple microphones used in the speakerphone mode determine the position of a participant of a telephone call to limit reception of extraneous noise at the speakerphone by using microphone beam steering. Once the participant's position is determined, multiple speaker devices direct audible sounds of the telephone call in a beam towards the participant to improve the audibility of the call. Forming a beam towards the participant provides improved privacy since individuals outside of the beam will have greater difficulty hearing the call. The end user can turn the volume of the speaker to a lower setting with greater audible energy directed towards the end user by speaker beam steering. Beam forming of the microphone also improves privacy since the end user will have his voice picked up more clearly and thus be able to speak more quietly. Selectively engaging additional microphones and speakers when the speakerphone is used and turning off the additional microphones and speakers when the speakerphone is not used provides microphone and speaker beam steering during speakerphone usage without interfering with handset communications when the speakerphone is not used.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a portable information handling system wireless telephone handset having microphone and speaker beam steering;

FIG. 2A depicts the portable information handling system wireless telephone handset used to support a telephone call in a handset configuration;

FIG. 2B depicts the portable information handling system wireless telephone handset used to support a telephone call in a speakerphone configuration; and

FIG. 3 depicts a flow diagram of a process for communicating with the portable information handling system wireless handset in a handset or speakerphone mode.

### DETAILED DESCRIPTION

A portable information handling system wireless telephone handset communicates in a speakerphone mode by forming a beam of sounds output from plural speakers in a direction of a participant of a speakerphone telephone call. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

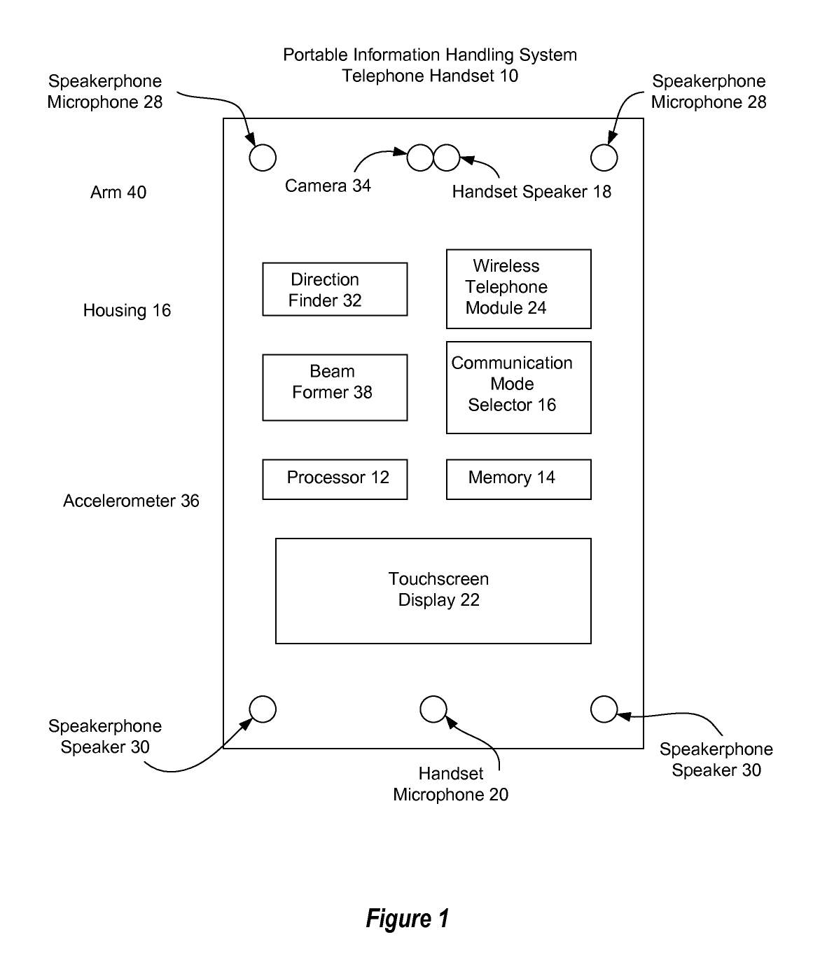

Referring now to FIG. 1, a block diagram depicts a portable information handling system wireless telephone handset 10 having microphone and speaker beam steering. Portable information handling system wireless telephone handset 10 is, for example, a smartphone having telephone, web browsing, email and texting capabilities run by a processor 12 executing applications stored in memory 14. To support use as a telephone, portable housing 16 is sized to fit in an end user's hand and held to the ear and mouth as a conventional telephone handset. When held as a conventional handset, housing 16 brings a handset speaker 18 proximate to an end user's ear and a handset microphone 20 proximate to an end user's mouth. The end user controls a telephone call with inputs made through a touchscreen display 22. For example, a user interface presented at touchscreen display 22 provides a keypad to input a telephone number and an icon to select a speakerphone mode or a handset mode for presenting the telephone call. Telephone calls are communicated through a wireless wide area network by a wireless telephone module 24, such as with a standard cell phone communication protocol. When the speakerphone mode is selected, a communication mode selector 26 activates speakerphone microphones 28 and speakerphone speakers 30 so that a total of three microphones and three speakers support a speakerphone telephone call. In alternative embodiments, the speakerphone mode may use any number of plural microphones and speakers. When the handset mode is selected, handset speaker 18 and handset microphone 20 support a handset telephone call. Although in some embodiments all speakers and microphones may be used to support a handset telephone call, in one example embodiment, speakerphone microphones 28 and speakerphone speakers 30 are disabled in the handset mode so that only handset speaker 18 and handset microphone 20 are active in the handset mode.

Upon selection of speakerphone mode for presenting a telephone call, speakerphone microphones 28 are activated along with handset microphone 20 to receive audible energy and convert the audible energy to signals for processing by processor 12. A direction finder 32 stored in memory 14 and executing on processor 12 analyzes the sounds detected by microphones 20 and 28 to determine the direction of a participant to the speakerphone telephone call. Direction finder 32 uses conventional beam forming to determine the direction of the participant, such as one-dimensional analysis used in existing portable information handling systems sold by DELL INC. that include dual microphone arrays and MICROSOFT ROUNDTABLE, or two dimensional analysis available with three microphones and a triangulation algorithm. In alternative embodiments, greater numbers of microphones may be used along with other types of microphone beaming algorithms. Direction finder 32 determines the direction from portable information handling system telephone handset 10 to the speakerphone call participant and then provides input isolation by creating a focused input “beam” centered around the microphones in the direction of the participant. Direction finder 32 effectively cancels noise that is picked up outside of the microphone beam defined by the three microphones in the direction of the participant.

In addition to the direction determined by analysis of the three-microphone array, other information gathered by sensors of portable information handling system telephone handset 10 may be used to determine if a speakerphone mode is desired by an end user and to determine a participant direction. In one embodiment, voice identification by direction finder 32 of a voice associated with an end user of portable information handling system telephone handset 10 allows concentration on sounds of an identified voice for directional analysis while filtering extraneous noises. In another embodiment, a camera 34 captures an image for analysis by direction finder 32 to determine a direction to a speakerphone telephone call participant. The participant may be determined based on a detected behavior, such as facing and speaking at the camera, or with a facial identification. Alternatively, if an image captured by camera 34 corresponds with a direction determined from analysis of sounds captured by speakerphone microphones 28 and handset microphone 20, then the image provides improved beam steering and movements of the image are applied to guide changes in the direction of the beam defined by direction finder 32. In another embodiment, an accelerometer 36 integrated in housing 16 determines the orientation housing 16 relative to gravity. Direction finder 32 applies accelerations detected by accelerometer 36 to determine if movement of portable information handling system telephone handset 10 introduces a change in the direction towards a speakerphone telephone call participant. In one embodiment, communication mode selector 26 applies the acceleration of accelerometer 34 to determine whether to present a phone call in the speakerphone or handset mode. For instance, communication selector 26 automatically initiates a speakerphone mode if housing 16 rests flat as determined by accelerometer 34.

Once direction finder 32 determines a direction to a speakerphone telephone call participant, a beam former 38 applies the direction to beam steer sounds output by handset speaker 18 and speakerphone speakers 30 at the participant of the speakerphone phone call. Speaker beam forming uses audio interference patterns to direct the output of audio from speakers in a desired direction while blanking sound from escaping in other directions. The direction for beam steering of audio output from portable information handling system telephone handset 10 is based upon the direction to a participant in a speakerphone telephone call as determined by direction finder 32. The use of three speakers and three microphones allows steering of a two dimensional beam for sounds output by the speakers and sounds received at the microphones. As direction finder 32 detects changes in the direction to the participant, beam former 38 adjusts sounds output by speakers 18 and 30 to steer audio output of the speakerphone call towards the participant's new direction. If direction finder 32 detects multiple participants to a speakerphone telephone call, beam former 38 steers audio output in the direction of each detected participant. In one embodiment, direction finder 32 and beam former 38 learn the voices of participants to speakerphone telephone calls to more quickly identify and steer towards a participant. By separating the identity of persons speaking, sound optimization is available, such as individual equalization for each end user, allowing improved beam forming for only those speakers indicated as most relevant. In one embodiment, to aid in more accurate beam steering, an arm 40 extends out from housing 16 in a predetermined direction and distance so that microphones and speakers are further distal from each other.

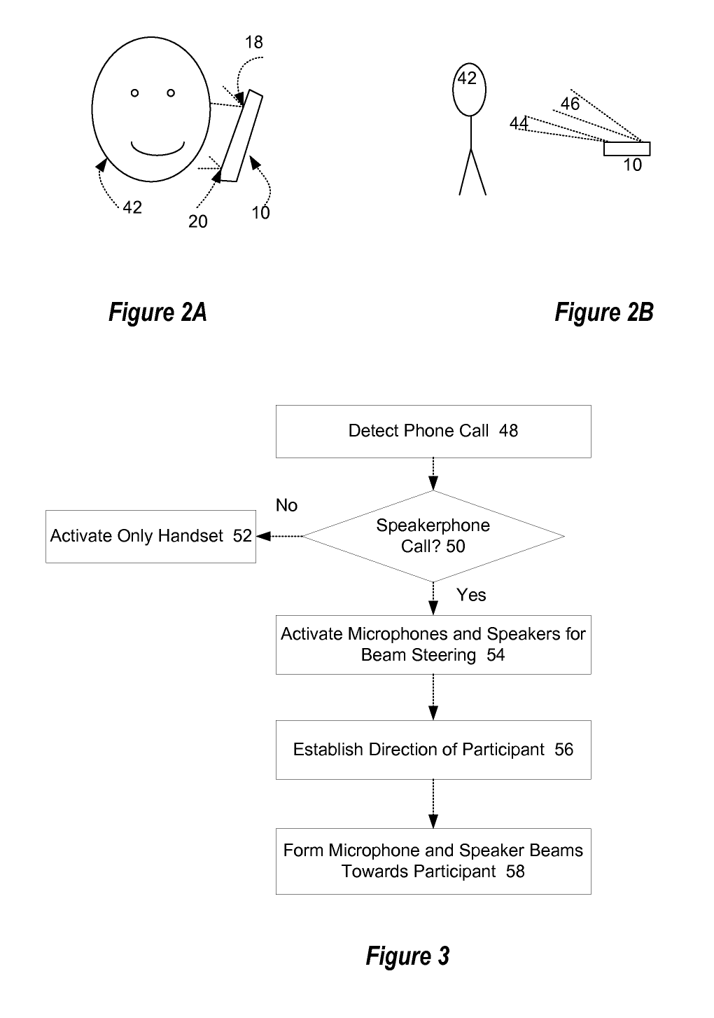

Referring now to FIGS. 2A and 2B, the portable information handling system wireless telephone handset 10 is depicted used to support a telephone call in a handset configuration and speakerphone configuration. In the handset mode depicted by FIG. 2A, portable information handling system telephone handset 10 is held proximate the head of an end user 42 so that the handset speaker aligns near the end user's ear and the handset microphone aligns near the end user's mouth. In the speakerphone mode depicted by FIG. 2B, portable information handling system telephone handset 10 is placed distal end user 42, such as flat on a table or other surface. The end user participant 42 of a speakerphone telephone call is determined based upon a microphone beam 44 defined from participant 42 to portable information handling system telephone handset 10. Based upon the direction of microphone beam 44, a speaker beam 46 is defined to direct audio of the telephone call towards participant 42.

Referring now to FIG. 3, a flow diagram depicts a process for communicating with the portable information handling system wireless handset 10 in a handset or speakerphone mode. At step 42, a telephone call is detected, such as by the placement of a telephone call from the handset or reception of a portable call through a wireless wide area network to the handset. At step 50, a determination is made of whether the telephone call is in the handset mode or the speakerphone mode. The determination at step 50 is primarily made by the end user's selection at a user interface of the appropriate mode, however, in alternative embodiments automated determinations may be made. For example, an accelerometer input that the handset is flat on a table may automatically initiate a speakerphone mode while an accelerometer input that the handset is at an angle may automatically initiate a handset mode. As another example, an image of an ear captured by a camera may initiate a handset mode while an image of a face several feet away may initiate a speakerphone mode. If a handset mode is detected, the process continues to step 52 to activate only the single handset speaker and microphone for the handset mode. In alternative embodiments, plural speakers and microphones may be used in the handset mode with beam steering to direct the sounds at the microphones and speakers in the handset mode.

If at step 50 a determination is made to use the speakerphone mode, the process continues to step 54 to actuate plural microphones and speakers for microphone and speaker beam steering. At step 56, a direction is established from the portable information handling system telephone handset to the participant or participants of the speakerphone telephone call. For example, microphone beam steering analyzes a direction to a voice identified as associated with an end user of the handset. As another example, a camera image is analyzed to determine a speaker based on facial identification or behaviors associated with speaking to a speakerphone. Once the direction is established to the participant or participants of the speakerphone telephone call, the process continues to step 58 to form a microphone and speaker beam in the direction of the participant or participants. As the speakerphone telephone call proceeds, updates to the direction of the participant are tracked by changes in the microphone beam or camera image and provided to the speaker beam former to maintain the speaker beam steered towards the participant.

Although the present invention has been described in detail, it should be understood that various changes, substitutions and alterations can be made hereto without departing from the spirit and scope of the invention as defined by the appended claims.

1. An information handling system comprising:
a housing;
plural microphones disposed at the housing and operable to capture audible sounds as audio information;
plural speakers disposed at the housing and operable to present audio information as audible sounds;
a direction finder interfaced with the plural microphones and operable to analyze audio information from the plural microphones to determine the direction of a sound source; and
a beam former interfaced with the direction finder and the plural speakers, the beam former operable to form a beam of the audible sounds by adjusting the output by the plural speakers, the beam directed towards the sound source.

2. The information handling system of claim 1 further comprising:
a touchscreen operable to present visual information and accept user inputs; and
a telephone module operable to establish telephone communication, the telephone module selectively presenting the telephone communication in a speakerphone mode or a handset mode based upon an end user selection at the touchscreen;
wherein one of the microphones and one of the speakers are disposed at the housing in a handset configuration, and only the one of the microphones and one of the speakers are active during telephone communication in the handset mode.

3. The information handling system of claim 2 wherein the sound source comprises a predetermined voice learned by the direction finder.

4. The information handling system of claim 2 wherein the direction finder is further operable to focus the microphones towards reception of audible sounds of the sound source.

5. The information handling system of claim 2 wherein the plural microphones and plural speakers comprise three microphones and three speakers integrated at predetermined locations of the housing, the direction finder and beam former triangulating sounds based upon the predetermined locations.

6. The information handling system of claim 1 further comprising at least one arm selectively extending from the housing to a predetermined location relative to the housing, the at least one arm having at least one of the microphones, the direction finder locating the sound source by triangulating based in part on the predetermined location of the arm.

7. The information handling system of claim 1 wherein the direction finder determines the direction of a first and second sound source, and the beam former forms a beam to the first and second sound sources.

8. The information handling system of claim 1 further comprising a wireless telephone module operable to establish telephone communications through a wireless wide area network and to present the telephone communications at the plural speakers and plural microphones in a speakerphone mode.

9. A method for performing a speakerphone telephone call from a wireless handset, the method comprising:
analyzing sounds at plural microphones of the wireless handset to determine a direction of a participant of the speakerphone telephone call relative to the wireless handset; and
forming a beam by adjusting output from plural speakers of the wireless handset to direct sounds of the speakerphone telephone call in the direction of the participant.

10. The method of claim 9 further comprising:
accepting a selection at the wireless handset to present a telephone call as a speakerphone telephone call or a handset telephone call;
in response to selection of a speakerphone telephone call, activating the plural speakers and plural microphones; and
in response to selection of a handset telephone call, activating only one speaker and one microphone, the activated speaker and microphone having a handset configuration.

11. The method of claim 9 further comprising forming a beam with the plural microphones to focus reception of sounds from the direction of the participant.

12. The method of claim 9 further comprising:
analyzing sounds received by the plural microphones to identify a voice associated with an end user of the wireless handset; and
in response to identifying a voice associated with an end user of the wireless handset, determining that the end user is a participant of the speakerphone telephone call.

13. The method of claim 9 further comprising:
capturing an image with a camera integrated in the wireless handset;
analyzing the image to detect a participant of the speakerphone telephone call; and
applying the image to determine a direction to form a beam with the plural speakers.

14. The method of claim 13 further comprising:
determining a distance between the camera and the detected participant; and
based at least in part upon the distance, determining that a telephone call is a speakerphone telephone call or a handset telephone call.

15. The method of claim 9 further comprising:
extending one or more of the microphones a predetermined distance from the wireless handset; and
analyzing based at least in part on the predetermined distance.

16. The method of claim 9 further comprising:
extending one or more of the speakers a predetermined distance from the wireless handset; and
forming the beam based at least in part on the predetermined distance.

17. A system for selectively providing a handset or speakerphone mode at a wireless handset, the system comprising:
a communication mode selector operable to present a telephone call in a handset mode using one microphone and one speaker disposed in the wireless handset in a handset configuration or in a speakerphone mode using plural microphones and plural speakers disposed in the wireless handset;
a direction finder interfaced with the communication mode selector and operable to apply sounds detected by plural microphones in the speakerphone mode to determine a direction of a participant to a speakerphone telephone call; and
a beam former interfaced with the direction finder and operable to present sounds of the speakerphone telephone call in the direction of the participant determined by the direction finder by adjusting audible sounds output from plural speakers to form a beam of the sounds.

18. The system of claim 17 wherein the direction finder is further operable to focus reception of sounds with a beam formed by the microphones in the direction of the participant.

19. The system of claim 17 wherein the communication mode selector comprises a camera operable to capture an image and to determine a handset mode if the image has a participant within a first predetermined distance of the wireless handset and a speakerphone mode if the participant has a least a second predetermined distance from the wireless handset.

20. The system of claim 17 wherein the communication mode selector is further operable to disable the microphones and speakers not used by the handset mode when the handset mode is selected.
